(19) United States
(12) Patent Application Publication
(10) Pub. No.: US 2004/0259968 A1
(43) Pub. Date: Dec. 23, 2004

(54) Reactive polyurethanes having a low content of monomeric diisocyanates

(76) Inventor: Michael Krebs, Hilden (DE)

Correspondence Address: WOODCOCK WASHBURN LLP, ONE LIBERTY PLACE, 46TH FLOOR, PHILADELPHIA, PA, 19103, US

(21) Appl. No.: 10/873,884

(22) Filed: Jun. 22, 2004

Related U.S. Application Data
(63) Continuation of application No. PCT/EP02/14223, filed on Dec. 13, 2002.

(30) Foreign Application Priority Data
Dec. 22, 2001 (DE) 101 63 857.4

(51) Int. Cl. C08G 18/00; C08G 18/34; C08G 18/42; C08G 18/68; C08J 9/00

(52) U.S. Cl. 521/170; 528/84

(57) ABSTRACT

The invention relates to reactive polyurethane compositions that can be produced by reacting polyols with a stoichiometric excess of mixtures consisting of asymmetric polyisocyanates having a molecular weight of less than 600 and an NCO functionality ranging from 0.175 to 2.5 and high-molecular isocyanates. These reactive polyurethane compositions re suited for producing reactive hot-melt-type adhesives, solvent-free or solvent-containing laminating adhesives, assembly foams, casting compounds, soft/hard and integral foams and for producing reactive one-component or two-component adhesives/sealants.

### CROSS REFERENCE TO RELATED APPLICATIONS

This application is a continuation of PCT/EP02/14223, filed Dec. 13, 2002, which claims the benefit of DE 101 63 857.4, filed Dec. 22, 2001, the complete disclosures of which are hereby incorporated by reference in their entirety.

### FIELD OF THE INVENTION

The present invention concerns reactive polyurethane compositions having a low level of monomeric diisocyanates and also a process for their preparation and their use in reactive one and two component adhesive/sealant materials, assembly foams, potting compounds and also in flexible, rigid and structural foams.

### BACKGROUND

Reactive polyurethane adhesive/sealant materials, especially one component moisture-curing systems, generally comprise room temperature liquid polymers having urethane groups with or without urea groups and reactive isocyanate groups. There are many applications where these compositions are solvent free and very viscous and/or pasty, they are processed at room temperature or at slightly elevated temperature between about 50° C. and about 100° C.

Reactive one-component moisture-curing polyurethane hotmelt adhesives are moisture-curing or moisture-crosslinking adhesives which are solid at room temperature and are applied as an adhesive in the form of their melt, i.e., at substance temperatures between about 80° C. and 140° C., and whose polymeric constituents contain urethane groups and also reactive isocyanate groups. As this melt cools down after application and the substrate parts to be bonded together have been joined together the hotmelt adhesive initially undergoes rapid physical setting due to its solidifying. This is followed by the isocyanate groups still present undergoing a chemical reaction with moisture from the environment to form a crosslinked unmeltable adhesive. Reactive hotmelt adhesives based on isocyanate-terminated polyurethane prepolymers are described for example in H. F. Huber and H. Müller in “Shaping Reactive Hotmelts Using LMW Copolyesters”, Adhesives Age, November 1987, pages 32 to 35.

Laminating adhesives may either have a similar construction to reactive hotmelt adhesives, or they are applied as one-component systems from solution in organic solvents, a further embodiment consists of two-component solvent-containing or solvent-free systems in which the polymeric constituents of one component comprise urethane groups and reactive isocyanate groups and, in the case of the two-component systems, the second component comprises polymers or oligomers having hydroxyl groups, amino groups, epoxy groups and/or carboxyl groups. In the case of these two-component systems, the component which contains isocyanate groups and the second component are mixed, normally by means of a mixing and metering system, directly prior to application.

Assembly foams are produced in situ and they are therefore also referred to as in-situ foams (DIN 18159), more particularly they are moisture-curing one-component systems. The composition to be foamed is generally situated in pressurized disposible containers (aerosol cans). These polyurethane foams are used, in the construction industry in particular, for sealing, insulating and assembling, for example of joints, roof areas, windows and doors.

Reactive polyurethane adhesive/sealant materials are notable for a very high performance profile. These adhesive/sealant materials have therefore increasingly conquered new applications in recent years. Compositions for such adhesives and/or sealants are already known from very many patent applications and other publications.

As well as many advantages, however, these polyurethane compositions also have some systemic disadvantages. One of the most serious disadvantages is the residual monomer level of isocyanates, especially the more volatile diisocyanates. Adhesive/sealant materials and especially hotmelt adhesives are processed at elevated temperature. For example, hotmelt adhesives are processed between 100° C. and 200° C. and laminating adhesives between room temperature and 150° C. Volatile isocyanates such as TDI or IPDI have a not inconsiderable vapor pressure even at room temperature. This noticeable vapor pressure is particularly serious in the case of a sprayed application in particular, since, in spraying, significant amounts of isocyanate vapors can appear above the application target which are toxic on account of their irritant and sensitizing effect. The use of products having a high level of such volatile diisocyanates requires the user to take costly and inconvenient measures to protect the persons working with the product, especially costly and inconvenient measures to keep the air breathed clean, statutorily mandated by the maximum allowable concentration of working materials as gas, vapor or suspended matter in the air at the workplace (annually updated MAC value list of TRGS 900 technical regulation of German Federal Ministry Of Work And Social Affairs). These measures, such as for example the duty to monitor compliance with the maximum allowable concentration, are costly and inconvenient. Especially measures to suck away the vapors where they are formed and exit are very cost-intensive and, what is more, hinder some application processes, such as in particular the sprayed application of reactive polyurethane adhesive/sealant materials. Since the protective and cleaning measures mentioned are generally associated with high financial investments or costs, users have a need for products which, depending on the isocyanate used, have a very low fraction of volatile diisocyanates.

The presence of starting diisocyanate monomer not reacted with polyol leads to a presence of free monomeric diisocyanates in the adhesive bond which frequently migrate for example within the coating or adhesive bond or to some extent even in the coated or adhered materials. Contact with moisture converts the isocyanate groups of the migrating constituents, or migrates for short, continuously into amino groups and further metabolites.

These migrates are undesirable in polyurethane structural foams used for example in the manufacture of steering wheels for automotive vehicles, since skin contact with amines formed from migrated diisocyanates cannot be ruled out.

Migrates are also undesirable in the packaging sector, specifically in food packaging. Migration through the packaging material may lead to contamination of the contents; secondly, depending on the amount of the migrate-capable free monomeric diisocyanate, long waits are needed before the packaging material is migrate free and may be used.

The level of amines formed by migrated diisocyanates, especially primary aromatic amines, shall be below the aniline hydrochloride detection limit of 0.2 micrograms of aniline hydrochoride 100 ml of sample (German Federal Institute For Consumer Health Protection And Veterinary Medicine, BGVV, according to official collection of analytical methods under § 35 of the German Food Testing Act—Analysis Of Foods/Determination Of Primary Aromatic Amines In Aqueous Test Foods).

A further undesirable effect which may arise due to the migration of monomeric diisocyanates is the anti-seal effect which arises in the production of bags, including carrier bags, from laminated plastics film. Laminated plastics film is frequently coated with a lubricant based on fatty acid amides. Reaction of migrated monomeric diisocyanate with the fatty acid amide and/or moisture creates, at the film surface, urea compounds which have a melting point which can be above the sealing temperature of the plastics film. This leads to the formation, between the film parts to be sealed together, of a dissimilar, antiseal layer which hinders the formation of a uniform sealing seam.

The fields of use mentioned, such as for example reactive one- and two-component adhesive/sealant materials, assembly foams, potting compound and also flexible, rigid and structural foams, therefore would benefit greatly from the development of reactive polyurethane compositions having a dramatically reduced fraction of monomeric, volatile diisocyanates, since it is this development which in some instances permits their use in many applications in the first place where use has hitherto not been possible for the occupational hygiene problems described above. The term “volatile” as used herein is to be understood as meaning substances which have a vapor pressure of more than about 10⁻⁶ hPa at about 20° C. According to Schulz-Flory statistics for the reaction of diisocyanates having isocyanate groups of substantially equal reactivity with hydroxyl-containing compounds, the residual level of monomeric diisocyanate in the reaction product is dependent on the NCO/OH ratio of the reactants at prepolymer synthesis. An NCO/OH ratio of 2, which is frequently necessary for the prepolymer composition, will leave about 25% of the monomeric diisocyanate used as a monomer in the prepolymer. When a prepolymer synthesis employs for example 10% by weight of diphenylmethane diisocyanate (MDI) at an NCO/OH ratio of 2, on the order of about 2% by weight of monomeric MDI are found in the prepolymer in agreement with the abovementioned statistical estimate. Pure MDI has a vapor pressure of 0.8 mbar at 150° C., and although this vapor pressure is lower in compositions in accordance with Raoult's Law, it is still above the range generally recognized as safe by occupational hygienists. This means that, under the above-described application conditions, especially for a large-area application as a hotmelt adhesive in a thin layer, appreciable amounts of the residual monomer will pass into the overlying airspace and have to be removed by aspiration. A significant reduction in the monomer content by a power of ten through reduction in the NCO/OH ratio is generally not practicable, since the average molecular weight would then increase exponentially and the resulting polyurethane compositions would become extremely viscous and would no longer be processible. Prepolymer synthesis may therefore also be carried out in other ways in commercial practice. For instance, a sufficiently high NCO/OH ratio is used and, after the prepolymerization, the monomeric diisocyanate is removed in a second step, which may for example take the form of distillative removal of unconverted monomeric diisocyanate under reduced pressure or of subsequent chemical binding of the monomeric diisocyanate. For instance, EP-A-316738 describes a process for preparing urethane groups containing polyisocyanates having a urethane group free starting diisocyanate content of not more than 0.4% by weight by reacting aromatic diisocyanates with polyhydric alcohols and subsequently removing the unconverted, excess starting diisocyanate, wherein the distillative removal of the excess starting diisocyanate is carried out in the presence of an aliphatic polyisocyanate containing isocyanate groups.

According to DE 10013186, the distillative removal of monomeric isocyanates can be obviated by reacting an addition product of compounds having two isocyanate-reactive groups with a diisocyanate I in a first stage, Wherein either the diisocyanate or the isocyanate-reactive compound contains reactive groups having different reactivities. The ratios of diisocyanate and isocyanate-reactive compound that are employed are equimolar, so that the resulting addition product contains an isocyanate-reactive group and a free NCO group. If desired, an intermolecular addition reaction of this reaction product may then be carried out to form a polyaddition product which in turn contains an isocyanate-reactive group and an isocyanate group. This is followed by a reaction with a further diisocyanate II other than the aforementioned diisocyanate I.

EP-A-118065 describes a two-stage process for preparing polyurethane prepolymers having terminal isocyanate groups and a reduced residual diisocyanate monomer content by a first reaction of a monocyclic diisocyanate, preferably tolylene diisocyanate or isophorone diisocyanate (IPDI), with a polyfunctional alcohol in a ratio <1 for OH groups to NCO groups. A second step is carried out in the resultant prepolymer by making a dicyclic diisocyanate, preferably 4,4′-diphenylmethane diisocyanate or 4,4′-dicyclohexylmethane diisocyanate, react with polyfunctional alcohols in a ratio <1 for OH groups to NCO groups.

EP-A150444 proposes preparing polyurethane prepolymers having a low residual monomer content and a relatively low viscosity by reacting diisocyanates having isocyanate groups of different reactivities with polyfunctional alcohols in a ratio between 4 and 0.55 in a first reaction. After virtually all fast isocyanate groups have reacted with a portion of the available OH groups, when a reaction of the less reactive groups has not taken place as yet, a 2nd reaction stage comprises adding a diisocyanate which, compared with the less reactive isocyanate groups of the isocyanate of reaction step 1, is more reactive in an equimolar or excess amount, based on still available OH groups. It is said to be an advantage to be able to employ customary catalysts and elevated temperatures (40-100° C.). The first reaction is to be carried out with, in particular, aliphatic or aromatic asymmetrical, preferably monocyclic, diisocyanates (tolylene diisocyanate, isophorone diisocyanate) at a molar ratio of 0.6-1.0 for OH to NCO groups. The second reaction is said to be performable especially with aromatic or aliphatic dicyclic, preferably symmetrical diisocyanates (4,4′-diphenylmethane diisocyanate, 4,4′-dicyclohexylmethane diisocyanate) in a molar ratio of 0.6-0.8 for OH groups to NCO groups. Useful polyfunctional alcohols are said to be primary or secondary aliphatic alcohols having 2-6 OH groups, especially diols (C₂-C₅), triols (C₃-C₆), tetraols (C₄-C₈), OH-functional polyesters or polyethers of up to molecular weight 10000. The process products are claimed together with customary hardeners or moisture with or without organic solvents and accelerants for adhering together entities made of plastic, especially films. Bonding temperatures are set to be between 70 and 120° C. The last two references cited claim as an advantage that there is no nuisance due to volatile monocyclic diisocyanates when bonding together large areas. However, at these temperatures and especially at application temperatures of up to 160° for hotmelts, even dicyclic aromatic diisocyanates such as 4,4′MDI have a not inconsiderable volatility.

EP-A-0393903 describes a process for preparing prepolymers wherein monomeric diisocyanate is reacted with a polyol in a first step. Sufficient catalyst is then added for an appreciable portion of the residual isocyanate functionality to be converted into allophanate functionality. After the theoretical NCO content is reached, the reaction is stopped by rapid cooling and addition of salicylic acid.

WO-95/06124 describes polyurethane compositions which have a low fraction of monomeric diisocyanates and which are prepared by reaction of polyols with trifunctional isocyanates with or without addition of monofunctional chain terminators. The disadvantage with this process is the low availability of low molecular weight trifunctional isocyanates in that, more particularly, the trifunctional homologs of diphenylmethane diisocyanate are not commercially available in pure form.

According to WO 01/40342, polyurethane compositions having a low level of monomeric diisocyanates can be prepared in a two-stage process wherein a diol component having a molecular weight of less than 2000 and a monomeric diisocyanate having a molecular weight of less than 500 are reacted in a first step. The unconverted monomeric diisocyanate is removed from the reaction product and the resulting low-monomer macromolecular diisocyanate is reacted in a second step with a polyol to form a reactive prepolymer having isocyanate end groups. Such polyurethane compositions are said in this reference to be useful as binders for reactive one- or two-component adhesive/sealant materials, which may be solvent containing, and also, provided the polyols are chosen appropriately, for preparing reactive hotmelts.

DE 101 32571.1, yet to be published, proposes preparing reactive polyurethanes having a low level of monomeric isocyanates by reacting at least one asymmetrical diisocyanate monomer having a molecular weight from 160 g/mol to 500 g/mol with at least one diol having a molecular weight from 50 g/mol to 2 000 g/mol. The reaction is so selective that there is no need for additional workup and purification steps to remove excess monomer. These reaction products may be reacted directly in a second stage with higher molecular weight polyols to form the end point.

Although the products which are preparable according to the teachings of the last two references cited have very good processing properties and a low level of monomeric diisocyanates, it is desirable to further simplify the methods of making low-monomer reactive polyurethane composition. Desirable goals under the heading of further simplification include simplicity of reaction management, a very low viscosity for the reaction product and also good melt stability for the reactive polyurethane composition.

EP 693511 A1 describes reactive hotmelt systems which contain isocyanate groups. These compositions are reaction products of hydroxypolyols with ester and/or ether groupings of 15 to 150 hydroxyl number having an average functionality from 1.95 to 2.2 with diphenylmethane diisocyanates in a ratio from 1.4:1 to 2.5:1 for isocyanate groups in the diphenylmethane diisocyanates to hydroxyl groups in the polyols, wherein the diphenylmethane diisocyanate (MDI) comprises not less than 70% by weight of 2,4′-diphenylmethane diisocyanate. According to this reference, these reaction products have a low initial viscosity and an enhanced thermal stability (melt stability), so that they are said to be useful as solid adhesives for a wide range of applications. The residual diisocyanate monomer content of these products is not reported.

DE 10150722.4, yet to be published, teaches that reaction products of2,4′-diphenylmethane diisocyanate having a 2,4′-isomer fraction of not less than 95% by weight with at least one polyetherpolyol and/or polyalkylene glycol having a molecular weight below 1 000 and/or a fully or partly crystalline or glassily amorphous polyesterpolyol and also, if desired, room temperature liquid polyesterpolyols and/or polyetherpolyols having molecular weights above 1 000 can be reacted to form adhesive compositions which have a very low level of monomeric diisocyanate of less than 0.5% and preferably less than 0.25% by weight. Such hotmelt adhesive compositions are reported therein to have high melt stability and low viscosity as well as a low diisocyanate monomer content. Nothing is said in this reference about liquid or high-viscously pasty polyurethane adhesive or sealant materials or foams having a low residual monomer content.

### SUMMARY

The aforementioned prior art notwithstanding, there thus continues to be a demand for improved polyurethane compositions having a low fraction of monomeric diisocyanates that are useful as adhesive/sealant materials, foams and reactive hotmelt adhesives. More particularly, the raw materials used shall be readily available at low cost and be easy to react and performance properties such as bonding characteristics, ease of application, rate of cure shall be at least equivalent to those of conventional reactive polyurethane (hotmelt) adhesives, sealants, assembly foams, potting compounds and the like. The inventors therefore have for the object to provide polyurethane compositions which solve the last-mentioned problems.

This object is achieved by the present invention's solution as revealed in the claims. It consists essentially in providing reactive polyurethane compositions which are preparable by reactions of polyols with a stoichiometric excess of mixtures of asymmetrical polyisocyanates having a molecular weight below 500 and an NCO functionality from 1.75 to 2.5 and high molecular weight polyisocyanates.

### DETAILED DESCRIPTION

The present invention provides reactive polyurethane compositions which are preparable by reactions of polyols with a stoichiometric excess of mixtures of asymmetrical polyisocyanates having a molecular weight below 500 and an NCO functionality from 1.75 to 2.5 and high molecular weight polyisocyanates.

The present invention further provides a process for preparing polyurethane prepolymers having reactive NCO groups having a low level of polyisocyanates having a molecular weight (MW) below 500, in which

a) the asymmetrical polyisocyanate or polyisocyanates are reacted in a first reaction step with polyols in an NCO:OH ratio between 0.25 and 1.8:1

b) after reaction of virtually all comparatively highly reactive groups of the asymmetrical polyisocyanate or polyisocyanates from reaction step (a) of this reaction mixture, a high molecular weight polyisocyanate is added in stoichiometric equivalence to the remaining OH groups or preferably in stoichiometric excess and the reaction is completed if appropriate by addition of catalysts and/or by addition of heat.

The present invention further provides for the use of the polyurethane prepolymers prepared by the aforementioned process to prepare reactive one- or two-component adhesives, sealants, hotmelt adhesives, solvent-free/solvent-containing laminating adhesives, assembly foams, potting compounds, flexible, rigid and/or structural foams.

The first reaction step thus utilizes the selective reaction of asymmetrical polyisocyanates.

By selective reaction is meant a reaction of the monomeric asymmetrical diisocyanates with the diols under very benign conditions in order that the reactivity difference between the two NCO groups can be utilized for maximum selectivity.

Monomeric asymmetrical diisocyanates for the purposes of this invention are therefore such aromatic, aliphatic or cycloaliphatic diisocyanates having a molecular weight from 160 g/mol to 500 g/mol as possess NCO groups having different reactivities with regard to diols. The difference in the reactivity of the NCO groups of the diisocyanate is the result of different substituents adjacent to the NCO groups on the molecule, which for example reduce the reactivity of one NCO group compared with the other NCO group by steric screening, and/or by a different bond of one NCO to the rest of the molecule, for example in the form of a primary or secondary NCO group.

Examples of suitable aromatic asymmetrical diisocyanates are all isomers of tolylene diisocyanate (TDI) either in isomerically pure form or as a mixture of plural isomers, naphthalene 1,5-diisocyanate (NDI), naphthalene 1,4-diisocyanate (NDI), diphenylmethane 2,4′-diisocyanate (MDI) and also mixtures of 4,4′-diphenylmethane diisocyanate with the 2,4′-MDI isomer and 1,3-phenylene diisocyanate. Examples of suitable cycloaliphatic asymmetrical diisocyanates are for example 1-isocyanatomethyl-3-isocyanato-1,5,5-trimethylcyclohexane (isophorone diisocyanate, IPDI), 1-methyl-2,4-diisocyanatocyclohexane, 1,4-diisocyanato-2,2,6-trimethylcyclohexane (TMCDI), or hydrogenation products of the aforementioned aromatic diisocyanates, especially hydrogenated MDI in isomerically pure form, preferably hydrogenated 2,4′-MDI. Examples of aliphatic asymmetrical diisocyanates are 1,6-diisocyanato-2,2,4-trimethylhexane, 1,6-diisocyanato-2,4,4-trimethylhexane and lysine diisocyanate. The asymmetrical diisocyanate which is especially preferably used for preparing the composition of the present invention is 2,4′-diphenylmethane diisocyanate (2,4′-MDI) having a 4,4′-MDI and 2,2′-MDI content of less than 25%, preferably less than 5% and more preferably less than 1%. The 2,2′MDI content is below 0.4% in particular.

The selective reaction of the monomeric asymmetrical diisocyanates with the polyols takes place at a temperature between 20° C. to 100° C., preferably between 25-80° C. and more preferably between 40-75° C.

Useful polyols include a multiplicity of higher molecular weight polyhydroxy compounds. Preferred polyols are the room temperature liquid, glassily solid/amorphous or crystalline polyhydroxy compounds having two or three hydroxyl groups per molecule in the molecular weight range from 400 to 20000 and preferably in the range from 1000 to 6000. Examples are di- and/or trifunctional polypropylene glycols, but it is also possible to use random and/or block copolymers of ethylene oxide and of propylene oxide. A further group of polyethers preferred for use are the polytetramethylene glycols (poly(oxytetramethylene) glycol, polytetrahydrofuran) which are prepared for example by the acidic addition polymerization of tetrahydrofuran, the molecular weight range of the polytetramethylene glycols being between 600 and 6000 and preferably in the range from 800 to 5000.

Useful polyols further include the liquid, glassily amorphous or crystalline polyesters which are preparable by condensation of di- or tricarboxylic acids, such as for example adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid, dimer fatty acid or their mixtures with low molecular weight diols or triols respectively, such as for example ethylene glycol, propylene glycol, diethylene glycol, triethylene glycol, dipropylene glycol, 1,4-butanediol, 1,6-hexanediol, 1,8-octanediol, 1,10-decanediol, 1,12-dodecanediol, dimer fatty alcohol, glycerol, trimethylolpropane or mixtures thereof.

A further group of polyols to be used according to the present invention are the polyesters which are based on c-caprolactone and which are also known as “polycaprolactones”.

But it is also possible to use polyesterpolyols of oleochemical origin. Such polyesterpolyols are preparable for example through complete ring opening of epoxidized triglycerides with one or more 1 to 12 carbon atom alcohols of a fat mixture containing partly or wholly olefinically unsaturated fatty acid and subsequent partial transesterification of the triglyceride derivatives to alkyl esterpolyols having 1 to 12 carbon atoms in the alkyl moiety. Further suitable polyols are polycarbonate polyols and dimer diols (from Henkel) and also castor oil and its derivatives. Similarly, the hydroxyl-functional polybutadienes available under the “Poly-bd” tradename for example can be used as polyols for the compositions of the present invention.

Useful polyols further include linear and/or weakly branched acrylic ester copolymer polyols which are preparable for example by free-radical copolymerization of acrylic esters or methacrylic esters with hydroxy-functional acrylic and/or methacrylic acid compounds such as hydroxyethyl (meth)acrylate or hydroxypropyl (meth)acrylate. This method of preparation is such that the hydroxyl groups in these polyols are generally present in random distribution, so that the polyols in question here are either linear or weakly branched polyols having an average OH functionality. Although the difunctional compounds are preferred for the polyols, more highly functional polyols may also be used, at least in minor amounts.

The choice of polyol or polyols depends on the style of use of this adhesive/sealant material composition. In the case of highly viscous or pasty liquid adhesive/sealant materials, it is preferable to use at least predominantly liquid polyols. In the case of two-component adhesive/sealant materials, one component may comprise a prepolymer having reactive isocyanate end groups from the polyols and the other component a hydroxyl-functional polyol or a hydroxyl-functional polyurethane. But the high molecular weight diisocyanate can also be used as a hardener for a hydroxyl-functional component, in which case the hydroxyl-functional component comprises either one or more of the aforementioned polyols or a hydroxyl-containing polyurethane prepolymer.

When the polyurethane compositions of the present invention are used as reactive hotmelt adhesives, the polyol components are chosen such that the composition is solid at room temperature. This can either be done by using solid amorphous and/or solid crystalline polyhydroxy compounds, or else by co-using an appreciable fraction of short-chain polyhydroxy compounds, since these compositions are likewise solid at room temperature owing to the high concentration of urethane groupings. Selection criteria for the polyols are to be found for example in the aforementioned paper by H. F. Huber and H. Müller.

High molecular weight diisocyanates for the purposes of this invention are such diisocyanates as can be prepared by reaction of a diol having an average molecular weight from 60 to 2000 with a monomeric diisocyanate having a molecular weight of less than 500 in a stoichiometric excess of the diisocyanates over the OH groups, in which case these high molecular weight diisocyanates can be prepared by a process as described in WO 01/40342 at page 5 last para to page 9 para 3 or claims 7 to 9. The teaching of WO 01/40342 in relation to the preparation of high molecular weight polyisocyanates expressly forms part of the present invention. In a preferred embodiment, the high molecular weight diisocyanates are prepared using the aforementioned asymmetrical diisocyanates. In this way, the selective reaction of the monomeric asymmetrical diisocyanates with the diols having a molecular weight below 2000 can likewise be fully utilized, so that a mixture of the high molecular weight polyisocyanates which is obtained from a synthesis suitably conducted at suitable stoichiometric ratios and at low excess of monomeric diisocyanate, low reaction temperature, no addition of catalysts will contain only a low fraction of low molecular diisocyanate monomer. In such a case, the purification steps recommended by the teaching of WO 01/40342 to remove the monomeric diisocyanate can be omitted. This makes the production process of the present invention particularly economical.

The diols used for preparing the high molecular weight diisocyanates have a number average molecular weight Mn between 60 and 2000 and preferably less than 1500. The number average is based on the OH number of the diol, determined according to DIN 53240.

Any linear or weakly branched C2-C18-alkanediol can be used in principle. It is further possible to use low molecular weight polyethers and also low molecular weight alkoxylation products of aromatic dihydroxy compounds (diphenols).

Specific examples of diols to be used according to the present invention are ethylene glycol, 1,2-propanediol, 1,3-propanediol, 2,2-dimethyl-1,3-propanediol, 2-methylpropanediol, 1,6-hexanediol, 2,4,4-trimethyl- 1,6-hexanediol, 2,2,4-trimethyl- 1,6-hexanediol, 1,4-cyclohexanedimethanol, diethylene glycol, triethylene glycol, tetraethylene glycol, dipropylene glycol, tripropylene glycol, tetrapropylene glycol, polyoxytetramethylene glycol having a molecular weight of up to 650, alkoxylation products of bisphenol A, alkoxylation products of bisphenol F, of isomeric dihydroxyanthracenes, of isomeric dihydroxy-naphthalenes, of pyrocatechol, of resorcinol, of hydroquinone having up to 8 alkoxy units per aromatic hydroxyl group or mixtures of the aforementioned diols.

As will have become clear from the preceding remarks, there are two ways to prepare the reactive polyurethane compositions of the present invention:

One way comprises reacting the asymmetrical polyisocyanate or polyisocyanates with polyols in an NCO:OH ratio between 0.25 and 1.8:1 in a first reaction step (a) to form an OH-functional intermediate which is then further reacted with a high molecular weight diisocyanate as described in WO 01/40342 to form an isocyanate-terminated prepolymer or prepolymer mixture.

In a second, particularly preferred embodiment, this second reaction step (b) is carried out with high molecular weight diisocyanates which were prepared using asymmetrical diisocyanates as described above, so that there is no need for a purifying step to remove monomeric diisocyanates. A particularly useful asymmetrical diisocyanate is 2,4′-MDI having a high isomeric purity of above 90%, preferably above 95% and most preferably above 97.5% by weight of 2,4′-MDI, and the 2,2′-MDI content should be below 0.4%.

This second embodiment can also be carried out as a one-pot reaction wherein equimolar amounts of asymmetrical diisocyanate and high molecular weight diisocyanate are reacted conjointly with the polyol or with the polyol mixtures. The differences in the reactivity of the “fast” NCO groups of the asymmetrical diisocyanate compared with those of the high molecular weight diisocyanate ensure that the same effect according to the present invention is achieved in dramatically lowering the monomer content of the reaction product.

These processes provide polyurethane compositions whose residual monomer content is distinctly below 0.1% by weight.

The compositions of the present invention may where appropriate further comprise catalysts which speed the formation of the polyurethane prepolymer at its synthesis and/or the moisture curing after the adhesive/sealant material has been applied. Useful catalysts for the purposes of the present invention include for example the organometallic compounds of tin, of iron, of titanium, of bismuth such as tin(II) salts of carboxylic acids, for example tin(II) acetate, ethyl hexanoate and diethylhexanoate. A further class of compounds is that of the dialkyltin(IV) carboxylates. The carboxylic acids have 2, preferably at least 10 and especially 14 to 32 carbon atoms. Dicarboxylic acids can be used as well. Acids which may be expressly mentioned are adipic acid, maleic acid, fumaric acid, malonic acid, succinic acid, pimelic acid, terephthalic acid, phenylacetic acid, benzoic acid, acetic acid, propionic acid and also 2-ethylhexanoic acid, caprylic acid, capric acid, lauric acid, myristic acid, palmitic acid and stearic acid. Specific compounds are dibutyltin diacetate, dibutyltin maleate, dibutyltin bis(2-ethylhexanoate), dibutyltin dilaurate, dioctyltin diacetate, dioctyltin maleate, dioctyltin bis(2-ethylhexanoate), dioctyltin dilaurate, tributyltin acetate, bis(β-methoxycarbonylethyl)tin dilaurate and bis(β-acetylethyl)tin dilaurate.

Oxides, sulfides and also thiolates of tin can be used as well. Specific compounds are bis(tributyltin) oxide, bis(trioctyltin) oxide, dibutyltin bis(2-ethylhexylthiolate), dioctyltin bis(2-ethylhexylthiolate), dibutyltin didodecylthiolate, dioctyltin didodecylthiolate, bis(β-methoxycarbonylethyl)tin didodecylthiolate, bis(β-acetylethyl)tin bis(2-ethylhexylthiolate), dibutyltin didodecylthiolate, dioctyltin didodecylthiolate, butyltin tris(thioglycolic acid 2-ethylhexanoate), octyltin tris(thioglycolic acid 2-ethylhexanoate), dibutyltin bis(thioglycolic acid 2-ethylhexanoate), dioctyltin bis(thioglycolic acid 2-ethylhexanoate), tributyltin (thioglycolic acid 2-ethylhexanoate), trioctyltin (thioglycolic acid 2-ethylhexanoate) and also butyltin tris(thioethylene glycol 2-ethylhexanoate), octyltin tris(thioethylene glycol 2-ethylhexanoate), dibutyltin bis(thioethylene glycol 2-ethylhexanoate), dioctyltin bis(thioethylene glycol 2-ethylhexanoate), tributyltin (thioethylene glycol 2-ethylhexanoate) and trioctyltin (thioethylene glycol 2-ethylhexanoate) having the general formula Rₙ₊₁Sn(SCH₂CH₂OCOC₈H₁₇)₃₋ₙ, where R is an alkyl group having 4 to 8 carbon atoms, bis(β-methoxycarbonylethyl)tin bis(thioethylene glycol 2-ethylhexanoate), bis(β-methoxycarbonylethyl)tin bis(thioglycolic acid), and bis(β-acetylethyl)tin bis(thioethylene glycol 2-ethylhexanoate) and bis(β-acetylethyl)tin bis(thioglycolic acid 2-ethylhexanoate).

Aliphatic tertiary amines are also suitable, especially in the case of a cyclic structure. Useful tertiary amines also include those which additionally bear isocyanate-reactive groups, especially hydroxyl and/or amino groups. Specific examples are: dimethylmonoethanolamine, diethylmonoethanolamine, methylethylmonoethanolamine, triethanolamine, trimethanolamine, tripropanolamine, tributanolamine, trihexanolamine, tripentalamine, tricyclohexanolamine, diethanolmethylamine, diethanolethylamine, diethanolpropylamine, diethanolbutylamine, diethanolpentylamine, diethanolhexylamine, diethanolcyclohexylamine, diethanolphenylamine and also their ethoxylation and propoyxylation products, diazabicyclooctane (DABCO), triethylamine, dimethylbenzylamine (Desmorapid DB, BAYER), bisdimethylaminoethyl ether (Catalyst A 1, UCC), tetramethylguanidine, bisdimethylaminomethylphenol, 2-(2-dimethylaminoethoxy)ethanol, 2-dimethylaminoethyl 3-dimethylaminopropyl ether, bis(2-dimethylaminoethyl) ether, N,N-dimethylpiperazine, N-(2-hydroxyethoxyethyl)-2-azanorbornanes, or else unsaturated bicyclic amines, for example diazabicycloundecene (DBU) and also Texacat DP-914 (Texaco Chemical), N,N,N,N-tetramethylbutane-1,3-diamine, N,N,N,N-tetramethylpropane-1,3-diamine and N,N,N,N-tetramethylhexane-1,6-diamine. The catalysts may also be present in oligomerized or polymerized form, for example as N-methylated polyethyleneimine.

However, catalysts which are very particularly preferred are the derivatives of morpholine. Specific examples of suitable morpholino compounds are bis(2-(2,6-dimethyl-4-morpholino)ethyl)-(2-(4-morpholino)ethyl)amine, bis(2-(2,6-dimethyl-4-morpholino)ethyl)-(2-(2,6-diethyl-4-morpholino)ethyl)amine, tris(2-(4-morpholino)ethyl)amine, tris(2-(4-morpholino)propyl)amine, tris(2-(4-morpholino)butyl)amine, tris(2-(2,6-dimethyl-4-morpholino)ethyl)amine, tris(2-(2,6-diethyl-4-morpholino)ethyl)amine, tris(2-(2-methyl-4-morpholino)ethyl)amine or tris(2-(2-ethyl-4-morpholino)ethyl)amine, dimethylaminopropylmorpholine, bis(morpholinopropyl)methylamine, diethylaminopropylmorpholine, bis(morpholinopropyl)ethylamine, bis(morpholinopropyl)propylamine, morpholinopropylpyrrolidone or N-morpholinopropyl-N′-methylpiperazine, dimorpholinodiethyl ether (DMDEE) or di-2,6-dimethylmorpholinoethyl) ether.

The aforementioned morpholine derivatives have a particularly high catalytic activity, especially with regard to the water (moisture) isocyanate reaction. Very low catalyst concentrations are therefore sufficient for crosslinking or curing the adhesives, the concentrations of catalyst in the adhesive formulation can be between 0.001% and 2% by weight and preferably between 0.02% and 0.9% by weight.

The composition of the present invention may where appropriate further comprise stabilizers, adhesion-promoting additions such as tackifying resins, fillers, pigments, plasticizers and/or solvents.

“Stabilizers” for the purposes of this invention refers on the one hand to stabilizers which have a viscosity-stabilizing effect on polyurethane prepolymers during production, storage and use. These are for example monofunctional carbonyl chlorides, monofunctional high-reactivity isocyanates, but also non-corrosive inorganic acids, examples being benzoyl chloride, toluenesulfonyl isocyanate, phosphoric acid or phosphorous acid. Useful stabilizers for the purposes of this invention further include antioxidants, UV stabilizers or hydrolysis stabilizers. The selection of these stabilizers depends not only on the main components of the composition but also on the application conditions and the likely destabilizing stresses on the cured product. When the polyurethane prepolymer is predominantly constructed from polyether building blocks, there is mainly a need for antioxidants with or without UV protectants. Examples thereof are the commercially available sterically hindered phenols and/or thioethers and/or substituted benzotriazoles or the sterically hindered amines of the HALS (Hindered Amine Light Stabilizer) type.

When essential constituents of the polyurethane prepolymer consist of polyester building blocks, it is possible to use hydrolysis stabilizers, for example of the carbodiimide type.

The compositions of the present invention may further comprise adhesion-enhancing additions, preferably adhesion-enhancing migration-capable polyisocyanates which have a significantly lower vapor pressure than MDI. The addition of such adhesion-enhancing polyisocyanates is described in WO 01/40342 at pages 14 to 16. This teaching is hereby expressly incorporated in the present invention.

When the compositions of the present invention are used as hotmelt adhesives, adhesive/sealant materials, potting compounds, flexible foams, rigid foams or structural foams, they may further comprise tackifying resins, for example abietic acid, abietic ester, terpene resins, terpene-phenol resins or hydrocarbonaceous resins, and also fillers (for example silicates, talcum, calcium carbonates, clays or carbon black), plasticizers (for example phthalates) or thixotropicizing agents (for example bentones, pyrogenic silicas, urea derivatives, fibrillated or pulped short fibers) or color pastes or pigments.

For use as a laminating adhesive, the achievement of certain additional properties, such as thermal and chemical resistance, may additionally necessitate an addition of epoxy resins, phenolic resins, novolaks, resols or melamine resins and the like. Moreover, it is possible in this case for the reactive polyurethane compositions also to be prepared in solution, preferably in polar aprotic solvents. Preferred solvents have a boiling range from about 50° C. to 140° C. Although halogenated hydrocarbons are suitable as well, ethyl acetate, methyl ethyl ketone (MEK) or acetone are most preferred.

The reactive polyurethanes of the present invention and the reactive polyurethane compositions prepared therefrom are used in reactive one- and two-component adhesive/sealant materials, assembly foams, potting compounds and also flexible, rigid and structural foams. The use is accomplished for example as with customary known polyurethane adhesive/sealant materials as a reactive one- or two-component adhesive/sealant material, as a reactive hotmelt adhesive or as a solvent-containing adhesive in one- or two-component form. The essential advantage over known reactive one- and two-component adhesive/sealant materials, assembly foams, potting compounds and also flexible, rigid and integral foams is the significantly low fraction of migration-capable monomeric diisocyanates having a molecular weight below 500 g/mol which are not generally recognized as safe by occupational hygienists. A further advantage over known low-monomer reactive polyurethanes is economic in kind, since the low monomer content is achieved without inconvenient and costly workup steps. The benign, selective reaction provides reactive polyurethanes which, for example, are free of by-products (such as crosslinking or depolymerization products) typically produced in thermal workup steps. The selective reaction of asymmetrical diisocyanates with secondary diols gives sterically shielded reactive polyurethanes which provide polyurethane hotmelt adhesives having excellent melt stability.

The invention will now be illustrated with reference to some proof of concept experiments, wherein the selection of the examples shall not constitute a restriction of the scope of the present invention's subject matter. They merely model the functioning of the hotmelt adhesives to be prepared according to the present invention and their advantages with regard to low residual monomer content, bonding characteristics and also low viscosity and melt stability. Such hotmelt adhesives can be used for a multiplicity of adhesive bonding applications. They are applied in a conventional manner by spraying, by means of rolls, doctor blades and the like.

All amounts indicated in the examples which follow are percentages by weight and parts by weight, unless otherwise stated.

### EXAMPLES

Various reactive polyurethane compositions were prepared and tested for their performance characteristics. The results are summarized in the table which follows.

### Example 1

### Prior Art

A polyesterdiol of OH number 30 from dodecanedioic acid and hexanediol (Dynacoll 7380, from Degussa-Hüls) was reacted with pure 4,4′-MDI at 130° C. to constant reaction.

### Example 2

### Comparison

The teaching of WO 01/40342 was followed to initially react a polypropylene glycol) of Mn 750 with 4,4′-MDI at an NCO/OH ratio of 5.0. The excess MDI was removed in a thin film evaporator down to a value of below 0.1 %. This high molecular weight diisocyanate was subsequently reacted with the Dynacoll 7380 polyesterdiol.

### Example 3

### Comparison

The teaching of DE 101 507 22.4, still to be published, was followed to react pure 2,4′-MDI (more than 97.5% content of 2,4′isomer) with Dynacoll 7380.

### Example 4

### Inventive

An equimolar mixture of 2,4′-MDI and high molecular weight MDI (prepared as in Example 2) were reacted with Dynacoll 7380 at 130° C.

TABLE 1

| | | | | | MDI |
|---|---|---|---|---|---|
| | | Viscosity at | Open | Setting | monomer |
| Example | NCO/OH | 130° C. | time | time | mixture |
| 1 | 2.2 | 7400 mPas | 20 s | <5 S | 3.2% |
| 2 | 2.2 | 19400 mPas | 85 s | 55 s | <0.1% |
| 3 | 2.2 | 2400 mPas | 15 s | <5 s | 2.3% |
| | 1.6 | 6800 mPas | 20 s | <5 s | 0.3% |
| 4 | 2.0 | 8600 mPas | 25 s | <5 s | <0.1% |

The composition as per prior art Example 1 has good processing properties with regard to open time, low setting time and low processing viscosity, but the very high MDI monomer content of 3.2% by weight is disadvantageous. The composition of Example 2 has a very low monomer content of 0.1 %, but also the disadvantage of a high melt viscosity and also of a very long open time and of a very long setting time. The composition as per Example 3 has a very low viscosity at an NCO/OH ratio of 2.2 and desirably a very short setting time and a very short open time, so that fast production processes can be carried out with it, but there is a disadvantage in the still fairly high monomer content of 2.3%. When the NCO/OH ratio is lowered as taught by DE 101 507 22.4, still to be published, the monomer content decreases dramatically to 0.1%, setting time and open time are in a favorable range for very many applications and the melt viscosity is likewise in a very favorable range for most applications.

Inventive Example 4 shows that these compositions has a good melt viscosity for almost all applications, open time and setting time and likewise in a very favorable range, moreover the monomer content has been further reduced significantly compared with the variant of Example 3.

The disclosures of each patent, patent application, and publication cited or described in this document are hereby incorporated herein by reference, in their entireties.

Various modifications of the invention, in addition to those described herein, will be apparent to those skilled in the art from the foregoing description. Such modifications are also intended to fall within the scope of the appended claims.

What is claimed is:

1. A composition comprising:
at least one reaction product of polyols with a stoichiometric excess of mixtures of asymmetrical polyisocyanates having a molecular weight below 500 and an NCO functionality from 1.75 to 2.5 and high molecular weight polyisocyanates.

2. The composition of claim 1, wherein the high molecular weight polyisocyanates are reaction products of diols having an average molecular weight from 60 to 2000 with monomeric diisocyanates having a molecular weight of less than 500.

3. The composition of claim 2, wherein the high molecular weight polyisocyanates contain less than 10% by weight of monomeric diisocyanate.

4. The composition of claim 1, wherein the asymmetrical diisocyanate is at least one of aromatic diisocyanate, aliphatic diisocyanate, cycloaliphatic diisocyanates, tolylene diisocyanate, naphthalene 1,5-diisocyanate, naphthalene 1,4-diisocyanate, diphenylmethane 2,4′-diisocyanate, mixtures of 4,4′-diphenylmethane diisocyanate with the 2,4′-MDI isomer, 1,3-phenylene diisocyanate, 1-isocyanatomethyl-3-isocyanato-1,5,5-trimethylcyclohexane, 1,4-diisocyanato-2,2,6-trimethylcyclohexane, 1-methyl-2,4-diisocyanatocyclohexane, 1,6-diisocyanato-2,2,4-trimethylhexane, 1,6-diisocyanato-2,4,4-trimethylhexane, or lysine diisocyanate.

5. The composition of claim 1, wherein the asymmetrical diisocyanate is diphenylmethane 2,4′-diisocyanate having a 4,4′-MDI and 2,2′-MDI content of less than 10%.

6. The composition of claim 1, wherein the asymmetrical diisocyanate is diphenylmethane 2,4′-diisocyanate having a 4,4′-MDI and 2,2′-MDI content of less than and preferably less than 2.5%.

7. The composition of claim 1, wherein the diols having a molecular weight from 60 to 2000 are selected from the group consisting of C2- to C18-alkanediols, ethylene glycol, 1,2-propanediol, 1,3-propanediol, 2,2-dimethyl-1,3-propanediol, 2-methylpropanediol, 1,6-hexanediol, 2,4,4-trimethyl-1,6-hexanediol, 2,2,4-trimethyl-1,6-hexanediol, 1,4-cyclohexanedimethanol, diethylene glycol, triethylene glycol, tetraethylene glycol, dipropylene glycol, tripropylene glycol, tetrapropylene glycol, polyoxytetramethylene glycol having a molecular weight of up to 650, alkoxylation products of bisphenol A, alkoxylation products of bisphenol F, isomeric dihydroxyanthracenes, isomeric dihydroxynaphthalenes, pyrocatechol, resorcinol, and hydroquinone having up to 8 alkoxy units per aromatic hydroxyl group, or mixtures thereof.

8. The composition of claim 1, wherein the polyol is selected from the group consisting of di- or trifunctional polyethylene glycols, polypropylene glycols, random or block copolymers of ethylene oxide and propylene oxide, poly(oxytetramethylene) glycols, polyesterpolyols, poly-ε-caprolactones, hydroxyl-functional polybutadienes or hydrogenation products thereof, and hydroxyl-functional poly(meth)acrylates, or mixtures thereof.

9. The composition of claim 1, wherein the polyol has a number average molar mass of 400 to 20000.

10. The composition of claim 1, wherein the polyol has a number average molar mass of 1 000 to 6000.

11. A method for preparing polyurethane prepolymers, comprising:
reacting asymmetrical polyisocyanate with polyols in an NCO:OH ratio between 0.25 and 1.8:1; and thereafter,
adding high molecular weight polyisocyanate.

12. The method of claim 1 1, wherein the high molecular weight polyisocyanate is added in stoichiometric excess.

13. The method of claim 11, further comprising adding heat or a catalyst.

14. The method of claim 11, wherein the OH:NCO ratio in the step of adding is 0.4 to 0.7:1.

15. The method of claim 11, wherein the method is carried out at temperatures between 40° C. and 130° C.

16. The method of claim 11, wherein the method is carried out at temperatures between 60° C. and 110° C.

17. The method of claim 11, wherein the step of reacting is carried out at temperatures between 40° C. and 80° C.

18. A reactive one- or two-component adhesive/sealant comprising the composition of claim 1.

19. A reactive hotmelt adhesive comprising the composition of claim 1.

20. A laminating adhesive comprising the composition of claim 1.

21. The laminating adhesive of claim 20 wherein the adhesive is solventless.

22. An assembly foam comprising the composition of claim 1.

23. A potting compound comprising the composition of claim 1.

24. A foam comprising the composition of claim 1.

25. The foam of claim 24, wherein the foam is a rigid foam, a flexible foam, or a structural foam.
